(19) United States
(12) Patent Application Publication
(10) Pub. No.: US 2006/0283987 A1
(43) Pub. Date: Dec. 21, 2006

(54) Multi-port fluid application system and method

(76) Inventor: Steven R. Anderson, Edina, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/157,265

(22) Filed: Jun. 21, 2005

(51) Int. Cl. B05B 1/20

(52) U.S. Cl. 239/566; 239/570

(57) ABSTRACT

A multi-port application system for applying or dispensing fluids such as adhesives to a substrate at relatively high pressures. The dispensing system includes a manifold chamber and a plurality of nozzles in which the inner end of each nozzle is spaced inwardly of the inner manifold chamber wall. The method includes applying the fluid at a pressure of at least 100 psi.

### BACKGROUND OF THE INVENTION

1. Field of the Art

The present invention relates generally to a fluid application system and method and more particularly to a multi-port fluid application system and method for dispensing and applying adhesives through a multi-port dispenser or other relatively high viscosity materials to a substrate

2. The Prior Art

The present invention relates to the application or dispensing of relatively high viscosity materials onto a substrate, but has particular applicability to the application or dispensing of adhesives onto a first substrate for lamination to a second substrate. Particular application of the present invention is in the application of single part/quick set adhesives and in the manufacture of various products such as structurally insulated panels (SIPS). Such manufacturing processes involve dispensing adhesive onto the major surfaces of one or more substrates for lamination into a structurally insulated panel.

Conventionally, adhesive is applied to the surface of such substrates via a plurality of nozzles or orifices. However, because of the possible premature curing of such adhesives and various other issues, a number of problems have arisen. Some of these, among others, include the uneven distribution of material onto the substrate, the inability to apply a uniform and consistent bead of adhesive, the plugging of nozzles, the restriction of orifices resulting from contamination in the material, the curing or drying of adhesive material at the outlet orifice or tip and the trapping of air in the top of the manifold, thereby causing material to run on or drip and/or cure inside the manifold.

Accordingly, there is a need for a multi-port fluid application system and a multi-port manifold/nozzle assembly which addresses these problems.

### SUMMARY OF THE INVENTION

The present invention relates to a fluid application system and method and more particularly to a multi-port or multi-nozzle manifold or manifold assembly for dispensing adhesives or other materials onto a substrate. Although the apparatus and method of the present invention is applicable to the dispensing of a wide variety of adhesives and other materials, it has particular applicability to the dispensing of relatively high viscosity materials and adhesives such as one part or moisture cured urethanes and other adhesives. One such application, for illustration only, is the application of adhesive to the individual substrates of a structurally insulated panel for subsequent lamination. In such application, beads of the adhesive are laid in various preset or layout patterns onto one surface of the substrate to be laminated. During this application process, it is preferable that the beads be continuous and of a constant diameter or flow rate and that the number of “globs” or uneven areas be minimized. The individual substrates are then laminated to one another in accordance with processes known in the art. If more than two substrates are to be laminated, this process is then repeated.

In general, the apparatus in accordance with the present invention includes a pressurized source of adhesive or other fluid to be dispensed, a manifold chamber, a valving mechanism for delivering material from the fluid source to the manifold chamber and a plurality of nozzles extending from the manifold chamber. In the preferred embodiment of the present invention, the inner end of each nozzle is spaced inwardly from the inner surface of the manifold bore. By extending the nozzle into the housing bore in this manner, contamination which normally settles at the bottom of the manifold chamber and results in clogged nozzles, will not be able to enter the nozzle orifices. Further, if nozzles need to be cleaned by inserting a wire, probe, drill or the like through the nozzle orifice and into the manifold, the crud and other impurities removed from the nozzle will settle to the bottom of the manifold bore rather than settling at the orifice opening.

A further feature of the present invention involves the relationship between the nozzles and the manifold and the ability of the individual nozzles to be easily cleaned and/or replaced.

A still further feature of the present invention relates to the particular relationship between the length of the nozzle orifice relative to the diameter of the nozzle orifice, the viscosity of the material to be dispensed, the application pressure and the desired flow rate through the nozzles. The nozzle of the present invention provides a structure which has a particular orifice diameter and length for a particular viscosity, or a range of viscosities, which will produce a desired flow rate when applied at given application pressure. Preferably this pressure is at least 100 psi, more preferably 300 psi or more and most preferably 500 psi or more. Because of the increased orifice length relative to the orifice diameter which is needed to produce the desired flow rates at these pressures and because of the surface tension of the fluid within the orifice, drooling or dripping of the adhesive at the tip of the orifice is minimized or eliminated.

Further, with the relationship between the orifice length and diameter and the applied material viscosity for a desired flow rate, the fluid can be applied at greater pressures without significantly affecting the application or metering of the fluid through the nozzles. This minimizes the variance between application flow rates through the various nozzles in the multi-port assembly and results in a more uniform application of material through such nozzles. Such relationship also allows for precise preset on/off control of flow through the nozzles so as to accurately and precisely dispense material in the desired patterns.

Accordingly, it is an object of the present invention to provide a multi-port application or dispensing system and method which reduces the problems associated with the dispensing of high viscosity adhesives and other fluids and results in a more uniform application of such material.

These and other objects of the present invention will become apparent with reference to the drawings, the description of the preferred embodiment and the appended claims.

### DESCRIPTION OF THE DRAWINGS

FIG. 1 is an isometric view of the multi-port adhesive dispensing system in accordance with the present invention.

FIG. 2 is an isometric view, partially in section, of the adhesive dispensing system of the present invention which is cut by a plane through the longitudinal axis of the valving mechanism.

FIG. 3 is an end view, partially in section, of the manifold block and a nozzle as cut by a plane through the manifold block and nozzle in a direction along the longitudinal axis of such nozzle.

FIG. 4 is a sectional view of a nozzle in accordance with the present invention as cut by a plane along through the longitudinal axis of the nozzle.

FIG. 5 is a view, partially in section, as viewed along the section line 5-5 of FIG. 4.

FIG. 6 is a view, similar to FIG. 4, of an alternate embodiment of a nozzle structure.

FIG. 7 is a schematic diagram showing a plurality of multi-port delivery systems joined together to deliver fluid to a substrate.

### DESCRIPTION OF THE PREFERRED EMBODIMENT

The present invention is directed generally to an adhesive or other high viscosity material dispensing system and method and more specifically to a multi-port manifold and nozzle assembly for dispensing adhesives or other relatively high viscosity materials. The invention is applicable to the dispensing of a wide variety of materials such as adhesives and other fluids. The preferred embodiment, however, will be described with respect to the dispensing of adhesives to a substrate in connection with the manufacture of structurally insulated panel or panels (SIPS). Further, although the invention has particular applicability to the dispensing of one part adhesives or other materials such as moisture cured urethanes or other adhesives, it is contemplated that certain aspects of the invention are also applicable to the dispensing of multi-part adhesives or other materials. The invention also contemplates the dispensing of adhesives or other materials from mixing or atomizing nozzles as well as nozzles with straight walls or non-atomizing orifices.

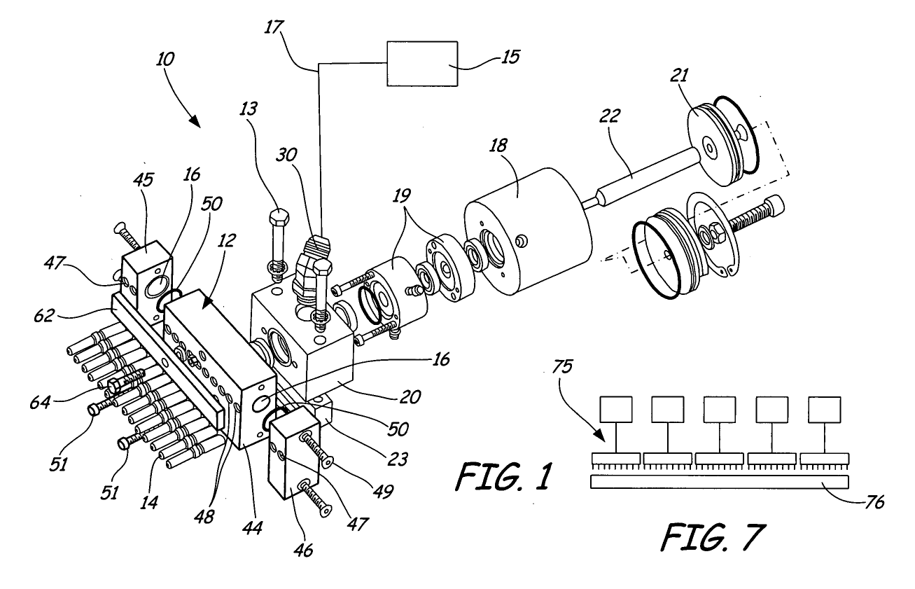

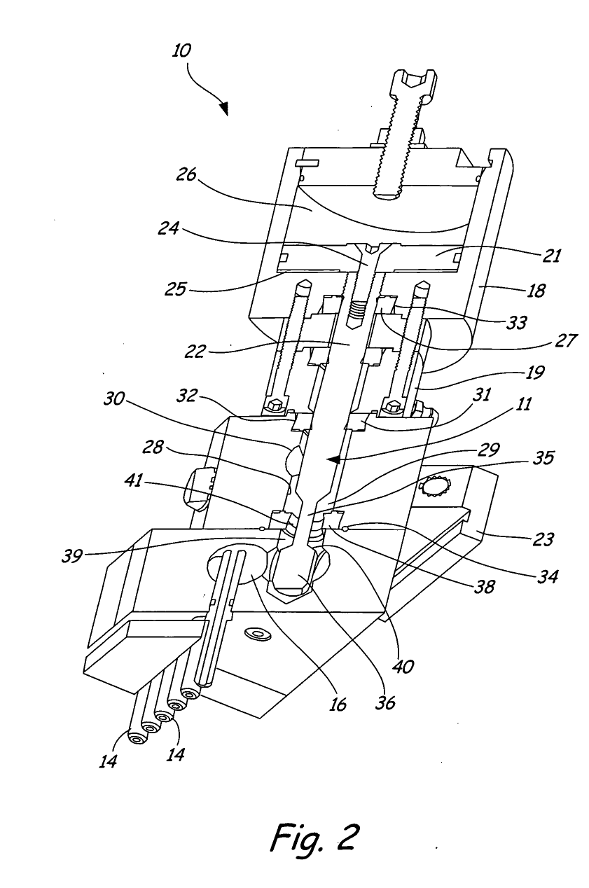

With reference to FIGS. 1 and 2, the dispensing system 10 in accordance with the present invention includes a valving mechanism 11, a manifold block 12 and a plurality of nozzles 14 extending from the manifold block for dispensing adhesive or other material to a substrate. During operation, the adhesive or material to be dispensed flows from a pressurized source of such material 15 (FIG. 1) through the valving mechanism 11 and to a manifold fluid chamber 16 within the manifold block 12. From there, the material is dispensed through the nozzles 14 to a substrate. In the preferred embodiment, the pressurized source is capable of delivering application fluid preferably at a pressure of at least 100 psi and more preferably at a pressure of at least 300 psi and most preferably at a pressure of at least 500 psi.

The system 10 includes a valve cylinder housing 18, an intermediate housing 19 and a material inlet and valve seal housing 20. The entire system is connected to a mounting bracket 23 via a pair of threaded members 13 extending through the housing 20. The valve cylinder housing 18 houses a valve control piston 21 which is connected with a valving rod 22 of the valve mechanism 11 by the threaded member 24. Pneumatic chambers 25 and 26 are provided on opposite sides of the piston 21 for driving the valving rod 22 between a closed and open position, respectively. The material inlet and seal housing 20 includes a central bore 28 defining a fluid inlet chamber 29 and a fluid inlet port 30. The port 30 provides communication between the chamber 29 and the pressurized source of dispensing fluid 15 (FIG. 1).

As shown best in FIG. 2, the housing 20 is connected in sealed relationship at its upper end to the intermediate housing 19 and at its lower end to the manifold block 12. The valving rod 22 extends longitudinally through the bore 28 from the upper end to the lower end of the housing 20. A seal 31 is seated within a larger diameter bore 32 at the upper end of the housing 20 to form a seal between the housing 20 and the axially moveable valving rod 22. A seal 27 is also seated within a larger diameter bore 33 to form a sealed relationship between the housings 18 and 19. The lower end of the housing 20 is sealed relative to the manifold block 12 via the O-ring 34. The valve mechanism 11 of the preferred embodiment is what is referred to as a snuffing valve. Such valve includes the elongated, axially moveable valving rod 22. The rod 22 includes a narrowed section 35 which extends through a valve seal 38 and an enlarged lower valving end 36.

The enlarged valving end 36 of the rod 22 is housed within a valve chamber 39 within the manifold block 12. The valving end 36 includes a beveled valve surface 40 designed for selective sealing engagement with an inner seal surface 41 of the seal member 38. The seal 38 is mounted within an enlarged seal seat bore 42 within the housing 20 and between the housing 20 and the manifold block 12.

During operation, the valving stem 22, and thus the valving end 36, move axially between an open position as shown in FIG. 2 in which the valving surface 40 is spaced from the seal surface 41 and a closed position (not shown) in which the valving surface 40 engages the seal surface 41 in a sealing relationship. Axial movement of the valving rod 22 is controlled by movement of the piston 21 which is in turn responsive to pneumatic pressure within the chambers 25 and 26. When the valve mechanism 11 is in its open position, as shown in FIG. 2, pressurized dispensing fluid is allowed to flow from the pressurized fluid source 15 through the supply line 17 and inlet 30, into the chamber 29, through the valving area between the seal surface 41 and valve surface 40, through the chamber 39 and into the manifold fluid chamber 16. Such fluid is then dispensed from the chamber 16 through the nozzles 14.

To close the valve mechanism 11, pneumatic pressure is introduced into the chamber 25. This causes the piston 21 and the valving rod 22 to move upwardly as shown in FIG. 2 and the valve surface 40 to move into sealing engagement with the seal surface 41. Because the valve mechanism 11 is a snuffing valve, as the valve closes, it draws a slight negative pressure in the chamber downstream from the valving surfaces. This prevents or limits any “run-on” or continued flow through the nozzles 14 after the valve is closed.

With reference to FIG. 1, the manifold of block 12 includes a center section or block 44 and a pair of end sections or blocks 45 and 46. The center block 44 includes the elongated manifold chamber 16 extending from one end to the other and a plurality of nozzle openings 48 to receive the plurality of nozzles 14 in the manner described below. The end blocks 45 and 46 are connected to opposite ends of the central block 44 by threaded members 49 which extend through the end blocks 45 and 46 where they are threadedly received by the central block 44. O-rings 50 are positioned between the end blocks 45, 46 and the central block 44 to seal the interface between such and the manifold fluid chamber 16. As shown best in FIG. 1, the manifold chamber 16 extends partially into each of the end blocks 45,46 and each of the end blocks 45,46 includes a pair of additional nozzle openings 47 similar to the nozzle openings 48. The manifold block 12 and in particular the central block 44 is connected with the housing 20 by a pair of threaded members extending through the block 44 and threadedly received by the housing 20. Overall, the preferred embodiment of the manifold chamber 16 extends about 6 inches to one foot or more in length. The manifold block may have as few as six or less nozzles or as many as fourteen or more nozzles. If the width of the substrate to which the fluid is to be applied is greater than the length of the manifold, several dispensing units can be ganged together in side-by-side relationship as shown in FIG. 7. In FIG. 7, four manifolds or dispensing units 75 are joined together for application of fluid to the substrate 76.

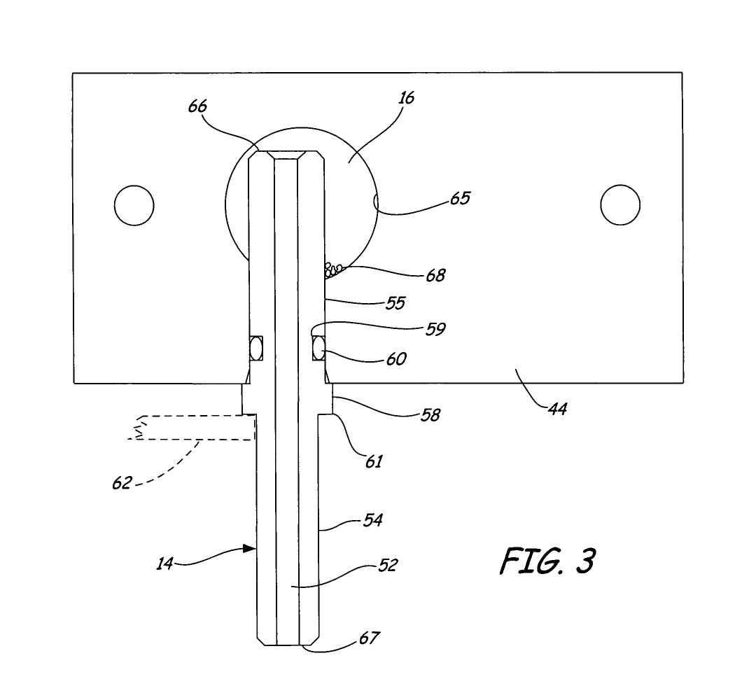

As shown best in FIGS. 2-5, each of the plurality of nozzles 14 is an elongated member having a central orifice 52 and a plurality of generally cylindrical outer surface portions. These outer surface portions include the outwardly extending portion 54, the manifold receiving portion 55, the clamping portion 58 and the O-ring seal seat portion 59. As shown best in FIG. 3, the manifold receiving portion 55 has an outer cylindrical dimension which is slightly smaller than the inside diametrical dimension of the nozzle openings 48 in the block 44. This permits the inner ends of the nozzles 14 to be inserted into the block 44 through the openings 48 in a relatively close tolerance relationship. An O-ring 60 is provided within each of the O-ring seat portions 59 to provide a seal between the manifold receiving portion of the nozzle 14 and the nozzle opening 48.

The enlarged clamping portion 58 has an outer cylindrical dimension greater than the inner cylindrical dimension of the opening 48. This limits the extent to which the nozzle 14 can be inserted into the opening 48. The transition between the larger diameter clamping portion 58 and the smaller diameter portion 54 provides a shoulder 61 against which a clamping bar or member 62 can be seated. As shown in FIG. 3 as well as in FIGS. 1 and 2, the clamping bar 62 is an elongated member which is connected with the block 44 via the threaded member 64 (FIG. 1). By securing the clamping bar 62 to the block 44 via the threaded member 64, a clamping edge of the bar 62 engages the clamping shoulder 61 of each nozzle, to retain the nozzle within the block 44. With this structure, the nozzles 14 are selectively and easily removable for replacement and/or cleaning by removing the clamping bar 62 and withdrawing the nozzles. It is, however, contemplated, that a variety of other clamping or connection mechanisms known in the art can be utilized for connecting the nozzles 14 relative to the block 44.

As illustrated best in FIGS. 2 and 3, the inner or manifold receiving end of the nozzle, which is defined by the portion 55, is sufficiently long so that it extends through a portion of the block 44, past the interior bore surface 65 defining the chamber 16, and into the manifold chamber 16. Thus, in the structure shown in FIGS. 2 and 3, the inner end 66 of the nozzle is positioned within the chamber 16 and inwardly of the bore surface 65 defining the chamber 16. Preferably, the end 66 extends at least about 25% into the chamber 16 past the bore 65, more preferably at least about 50% into the chamber 16 past the bore surface 65 and most preferably at least about 75% into the chamber 16 and past the bore surface 65.

By extending the end 66 into the chamber 16 and past the bore surface 65, impurities or crud such as the material 68 in FIG. 3 will settle and accumulate in the bottom of the chamber 16 rather than at the opening of the nozzle orifice 52 where such impurities can be dispensed onto the substrate or can clog the orifice 52.

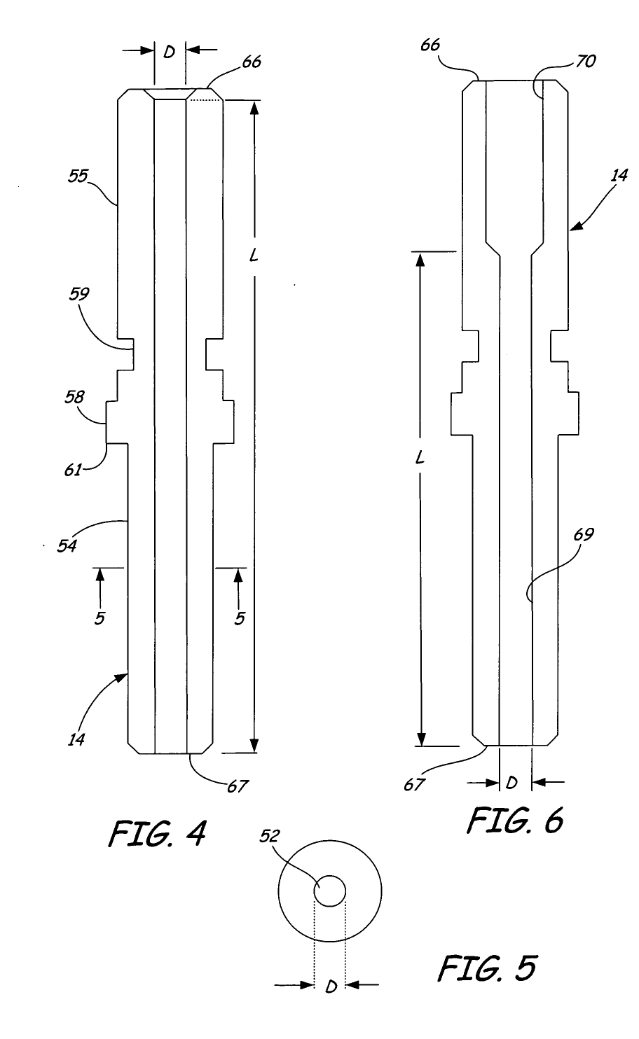

With continuing reference to FIGS. 2-5, and more specific reference to FIGS. 4 and 5, each nozzle includes an orifice having an orifice diameter “D” and an orifice length defined by the dimension “L”. In the preferred embodiment, the orifice 52 is a substantially straight walled orifice extending from near its inner end 66 to its outer end 67. A straight walled orifice as used herein defines an orifice in which the sidewalls defining the orifice are substantially straight and define an orifice size (cross-sectional area) which is substantially constant throughout the length of such orifice. Thus, as shown best in FIGS. 4 and 5, the walls defining the generally cylindrical orifice 52 extend in straight lines from near the inner end 66 of the nozzle 14 to its outer end 67. If the orifice is not straight walled, but is curved or has some other configuration, it is still preferable that the orifice be of substantially constant diameter. In either case, the orifice begins at or near the outer end 67 and extends toward the inner end 66.

The orifice length “L” as used herein with respect to a straight walled orifice is the length of the straight walled orifice 52 as shown in FIG. 4. Thus, the orifice length “L” is measured from the point where the straight walled orifice begins to where the straight walled orifice ends. Although the orifice length “L” can also be the same as the nozzle length (measured from the inner end 66 to the outer end 67), it does not need to be. In fact, as shown in FIG. 4, the orifice length “L” is slightly shorter than the nozzle length. FIG. 6 is a view similar to FIG. 4, but with a modified orifice 68 which begins at the end 67, but ends at a more significant distance from the inner end 66 of the nozzle. Thus, in FIG. 6, the length of the straight walled orifice is defined by the distance “L” measured from the end 67 to the point where the straight walled orifice 68 ends. The enlarged orifice portion 70 between the orifice portion 68 and the end 66 is not considered in defining the length “L” of the orifice in FIG. 6. In general, the orifice for purposes of defining the orifice diameter “D” and the orifice length “L” is the orifice portion with the smallest cross-sectional area.

If the orifice is not straight walled, but is curved, the orifice length is measured from the point where the constant cross-sectional area orifice portion begins to where that portion ends.

In accordance with a further aspect of the present invention, specific relationships exist between the orifice diameter “D” and the orifice length “L” relative to the viscosity of the dispensed fluid, the desired flow rate of fluid through the nozzle and the application pressure (the back pressure within the chamber 16 and the pressure at which the fluid is delivered by the fluid source 15).

Specifically, in a system with a known application pressure, the flow rate of the application fluid through the nozzles will be determined, and thus controlled, as a function of the application viscosity of that fluid and the length and diameter of the nozzle opening. Thus, for a given application pressure, an increase in the orifice length, a decrease in the orifice diameter or an increase in the viscosity will result in a corresponding decrease in the flow rate, while a decrease in the orifice length, an increase in the orifice diameter or a decrease in the viscosity will result in a corresponding increase in the flow rate.

In accordance with the preferred method, fluid is dispensed through the nozzles with an application or back pressure in the chamber 16 of at least 100 psi, more preferably at least 300 psi, and most preferably at least 500 psi By maintaining pressure of this magnitude in the chamber 16, any variances in flow rates through the various nozzles in the multi-nozzle assembly are minimized, thereby resulting in more uniform flow rates through the various nozzles and improved metering and control. Further, operation at these elevated pressures minimizes blockages which might occur within the nozzles. Thus, maintaining the above application pressures is particularly applicable to multi-nozzle systems such as the system of the present invention. The system of the present invention preferably has at least 6 laterally spaced nozzles and more preferably at least 10 laterally spaced nozzles.

For most applications utilizing the multi-port dispensing system of the present, the nozzles have an orifice length preferably between about 0.5 and 3.0 inches and more preferably between about 1.0 and 2.5 inches and an orifice diameter preferably between about 0.020 and 0.125 inches and more preferably between about 0.30 and 0.075 inches. With nozzle dimensions within these ranges, application fluids with an application viscosity of as high as 50,000 centipose (cps) or more which are applied as pressures at the above levels will result in a flow rate through the nozzles at a desired level of approximately 0.03 to 0.07 gallons per minute or more.

The method of dispensing an adhesive or other material in accordance with the present invention includes providing a source of pressurized fluid at a pressure of at least 100 psi, more preferably at least 300 psi and most preferably at least 500 psi and providing a manifold chamber with a plurality of application nozzles, each having an orifice length and an orifice diameter sufficient to deliver or apply a fluid of a known application viscosity at a desired flow rate.

Accordingly, a further aspect of the invention relates to a method of dispensing an adhesive or other fluid through a multi-port applicator at a relatively high pressure, preferably greater than 100 psi, more preferably greater than 300 psi and most preferably greater than 500 psi. With these application pressures, the method further involves selecting the nozzle length and diameter for such pressures to apply an adhesive or other fluid with a known application viscosity at a desired flow rate through the nozzle.

Preferably, the plurality of nozzles are straight-walled nozzles having an orifice length of about 0.5 to 3.0 inches and more preferably about 0.75 to 2.5 inches and an orifice diameter of preferably 0.020 to 0.125 inches and more preferably about 0.030 to 0.075 inches.

The viscosity of the fluids which can be delivered or applied with the system of the present invention can vary from application viscosities as low as 100 centipoise (cps) or lower to as high as 50,000 cps or greater. For purposes of the present invention, the unit of one (1) centipose is the viscosity of water.

Although the description of the preferred embodiment has been quite specific, it is contemplated that various modifications could be made without deviating from the spirit of the present invention. Accordingly, it is intended that the scope of the present invention be dictated by the appended claims rather than by the description of the preferred embodiment.

1. A multi-port, fluid application manifold assembly comprising:
a manifold having a manifold chamber defined by the surface of a manifold bore and
a plurality of nozzles mounted in said manifold, each of said nozzles having an inner and an outer end, the inner end of each of said nozzles extending into said manifold chamber such that said inner end is spaced inwardly from said manifold bore surface.

2. The manifold assembly of claim 1 wherein said manifold includes a nozzle opening corresponding to each of said plurality of nozzles.

3. The manifold assembly of claim 2 wherein each of said plurality of nozzles includes a manifold end extending into a corresponding one of said nozzle openings.

4. The manifold assembly of claim 3 including a seal member between an outer surface of said manifold end and said nozzle opening.

5. The manifold assembly of claim 4 wherein each of said plurality of nozzles includes a clamping shoulder and the manifold assembly further includes a clamping member connected with said manifold and a portion engaging said clamping shoulder.

6. The manifold assembly of claim 4 including means for retaining said plurality of nozzles within said corresponding nozzle openings.

7. The manifold assembly of claim 1 including a source of pressurized fluid to be applied and a valve moveable between an open position in which said pressurized fluid is open to said manifold chamber and a closed position in which said pressurized fluid is closed to said manifold chamber.

8. A multi-port fluid application system comprising:
a source of pressurized application fluid;
a multi-port manifold;
a valve moveable between an open position allowing flow of application fluid from said source of pressurized fluid to said manifold and a closed position preventing flow of application fluid from said source of pressurized fluid to said manifold;
a plurality of application nozzles connected with said manifold, each of said nozzles having an orifice with an orifice diameter less than about 0.125 inches and an orifice length of at least 0.75 inches.

9. The fluid application system of claim 8 wherein said plurality of nozzles are selectively removable from said manifold.

10. The fluid application system of claim 8 wherein said application fluid is maintained in said manifold at a pressure greater than about 100 psi.

11. The fluid application system of claim 10 wherein said orifice diameter is in the range of 0.020-0.125 inches.

12. The fluid application system of claim 11 wherein said orifice length is in the range of about 0.75-3.0 inches.

13. The fluid application system of claim 8 wherein said manifold includes a manifold chamber defined by the surface of a manifold bore and wherein each of said nozzles includes an inner end and an outer end, the inner end of each of said nozzles extending into said manifold chamber such that said inner end is spaced inwardly from said manifold bore surface.

14. The fluid application assembly of claim 13 wherein said manifold includes a nozzle opening corresponding to each of said plurality of nozzles.

15. The fluid application assembly of claim 14 wherein each of said plurality of nozzles includes a manifold end extending into a corresponding one of said nozzle openings.

16. The fluid application assembly of claim 15 wherein said manifold includes a seal member between an outer surface of said manifold end and said nozzle opening.

17. A method of applying an application fluid to a substrate comprising:
providing a source of pressurized application fluid at a pressure of at least 100 psi;
providing a multi-port manifold, said manifold having a manifold chamber and being selectively open to said source of pressurized fluid; and
providing a plurality of application nozzles, each of said nozzles connected with said manifold and having an orifice communicating with said manifold chamber, each said orifice having an orifice diameter and an orifice length of dimensions capable of delivering said application fluid at a desired flow rate when said manifold chamber is open to said source of pressurized fluid.

18. The method of claim 17 wherein said application fluid is an adhesive.

19. The method of claim 18 wherein said pressurized application fluid is at a pressure of at least 500 psi.

20. The method of claim 17 including providing a plurality of multi-port manifolds, each having a plurality of nozzles, and applying application fluid to said substrate simultaneously through said plurality of manifolds and nozzles.
